(19) United States
(12) Patent Application Publication
(10) Pub. No.: US 2011/0029415 A1
(43) Pub. Date: Feb. 3, 2011

(54) System and method for business or personal transactions

(76) Inventor: Alf Marcussen, San Francisco, CA (US)

Correspondence Address: David E. Orr, 4616 NE 134th Street, Vancouver, WA, 98686, US

(21) Appl. No.: 12/462,472

(22) Filed: Aug. 3, 2009

(51) Int. Cl. G06Q 10/00

(52) U.S. Cl. 705/30

(57) ABSTRACT

A computer system and method for recoding and controlling a business transaction involving a referral to the business made by a first party to a second party. Information about the first party and a referral incentive are recorded on the computer and then encoded on a two part card. The computer recording is retrievable by a unique identifier also encoded on the two part card. Certain auxiliary information related to the transaction are encoded on the business card. The first party gives the first card part to a second party. The second entity may, later, present the first card part to the business. Using the unique identifier the computer recording is retrieved. Using the two card parts and the retrieved computer information, the first party is identified, the incentive is conformed and the first party receives the incentive.

### RELATED APPLICATIONS

This application is a Continuation-In-Part of U.S. Patent Application 60/650,095 entitled SYSTEM AND METHOD FOR BUSINESS OR PERSONAL TRANSACTIONS, which is included herein by reference.

### FIELD

The present invention relates to computer methods for transacting business; more specifically the present invention relates to a computer system and method for initiating and consummating a transaction involving a business referral, wherein some of the elements of the transaction are recorded upon the computer system, retrievable by a unique identifier related to the referral, and printed upon media comprising two separable parts each having the unique number. The remaining elements are later recorded upon the printed media to complete the business referral transaction. The printed media are separated into two parts, the first part given to a business client, who, in turn gives the first part of the media to a referred person. The referred person visits the business, presents the first part of the printed media to the business. Using the unique number the computer record recoding the referral is retrieved and displayed. The second part of the media retained by the business is also examined to determine and confirm other aspects of the referral agreement.

### BACKGROUND

The most important business transactions involve a personal encounter or meeting between a potential customer, or a customer and a businessman or businesswoman. During this encounter, the businessperson informs and offers the customer a product or service. During the discussion with the prospect or customer, the businessperson learns more about the prospect and his or her needs or desires. From this discussion, an astute business person is able to discern the prospects specific interests in the product or service to be offered. Due to the dynamic nature of the transaction and the variability of the offer made, the businessperson has neither sales collateral nor a quote or proposal to give the customer delineating the offer made and the response to the offer by the customer.

In addition, businesses have discovered that referrals by customers have ten times the effectiveness of traditional advertising.

Therefore, what is needed is a mechanism for facilitating these types of dynamic business interactions wherein the businessperson may make, and record a referral offer to a prospect, and obtain information from the prospect and, at the same time provide the prospect with a receipt of the offer made, or to provide a prospect or customer with a referral incentive coupon that may be redeemed later.

### SUMMARY

A computer method for processing business referral agreements is disclosed. As exemplified in a preferred embodiment the present invention relates to a computer system and method for initiating and consummating a transaction involving a business referral, which are recorded upon the computer system—retrievable by a unique identifier—and are printed upon two part printable media, with each part having the unique identifier. The printed media is later modified by printing or writing upon the two part media additional aspects of the referral agreement. The printed media is separated into two parts, the first part given to a business client, who, in turn gives the first part of the media to a referred person. The referred person visits the business, presents the first part of the printed media to the business. Using the unique number the computer record recording of the referral is retrieved and displayed, and compared to the second part, which has been retained by the business. The second part of the media retained by the business is used to confirm the first part and is also examined to determine other aspects of the referral agreement, which have not been recorded on the computer system.

In an exemplary embodiment, a business computer system and method for executing a first-business transaction involving a first party, wherein aspects of the transaction is recorded upon the business computer system, the transaction including a referral to the first-business made by the first party to a second party. The method includes the referral incentive recorded upon the computer system and retrievable by a unique identifier. The referral incentive and the unique identifier are encoded on separable media having a first part and a second part, wherein each part of the media encodes identity of the first party and at least partially encodes the referral incentive offered by the first-business to the first party. The business may encode upon the two part media further aspects, modifications or additions to the referral incentive, and give the first part of the encoded media to the first party by the first-business. The first media part then is given to a second party by the first party. The second party presents the first media part to the first-business, and the first-business uses the first media part and the second media part to retrieve the computer record recording the incentive and to identify and confirm the incentive.

In the first aspect of the invention, the business computer system is operated by the first-business.

A second aspect of the invention comprises the system and method of the first aspect wherein the business computer system is operated by a second-business.

### OBJECTS AND ADVANTAGES

The first aspect of the invention provides the following advantages and benefits

1. A simple, inexpensive and effective way for a business to offer and manage referral incentives to a client, wherein the client refers the business to a prospect, the prospect visits the business and the referral is confirmed by both recording upon a computer system and dually encoding upon two part media, and confirm the referral by matching it the first part of the media with the second part of the media, or by finding the exact/unique/identifier (common to both parts) to confirm the validity of the coupon/serial number. Further confirmation is made by using the unique identifier to access a stored computer record.

2. By encoding the identity of the client and the referral incentive on two part separable media, the prospect “closes or completes” the referral transaction by presenting the first part of the media to the business.

3. By encoding the referral incentive on two part separable media, the business may modify or mitigate the referral incentive recorded upon the business computer system. Mitigation or modification is performed by writing or annotating, or encoding directly upon the two part media. The modifications may be machine readable, for example by bar-code.

4. By encoding the referral incentive on two part separable media, the prospect, by becoming knowledgeable of the incentive will be motivated to become a client and to receive referral incentives.

5. By dual recording (upon the computer system and the separable media), the incentive offer and the recipient of the incentive may be confirmed and verified.

Other benefits and advantages of the invention will appear from the disclosure to follow. In the disclosure reference is made to the accompanying drawings, which form a part hereof and in which is shown by way of illustration by exemplary embodiment in which the invention may be practiced. These exemplary embodiments will be described in sufficient detail to enable those skilled in the art to practice the invention, and it is to be understood that other embodiments may be utilized and that structural changes may be made in details of the embodiments without departing from the scope of the invention.

### BRIEF DESCRIPTION OF DRAWINGS

FIG. 1 depicts a computer system upon which the invention may be practiced.

FIG. 2 illustrates the steps by which business incentives may be recorded and by which a two-part separable card is made.

FIG. 3 shows the steps by which a business referral incentive is made and recorded.

FIG. 4 shows a customer making a referral of the business to a third party.

FIG. 5 shows the third party engaging the business to trigger the referral.

FIG. 6 shows the steps by which the two part card and the computer recording are used to identify and confirm the referral incentive.

FIG. 7 shows the computer processing steps required to compute an identification code related to the referral and related incentive.

### DETAILED DESCRIPTION

With reference to the included drawings, a system and method used by a business making a commitment to a first person referring the business to a second person. Information related to the business, the first person and the commitment are recorded on the system and printed on a card having two parts having a common identifier

Information recorded on either card part may be machine-readable and scanned and stored in a database. Information may be recorded, in part beforehand. Information may be hand-printed on the card in preset locations or may be hand-printed using a coding.

The various formats of the two-part card are described and illustrated in U.S. Patent Application 60/650,095 entitled SYSTEM AND METHOD FOR BUSINESS OR PERSONAL TRANSACTIONS, which is included herein by reference.

With reference to the included drawings, a system and method of using an encodable business card having two parts for recording information related to an offer made by a first entity to a second entity. Information is encoded on the two card parts and upon a computer system. The computer recording is retrievable by a unique identifier, which is also encoded on both parts of the two-part card. When the offer is made the first entity may also add additional information to the two card parts, and gives the first card part to the second party. The second party gives the first card part to a third party, who presents the first card part to the first party. The unique identifier on the first card part is used to retrieve the computer recording and the second matching card part. Using the two card parts and the retrieved and displayed computer recording, the business referral transaction is confirmed and verified

### Computing Environment

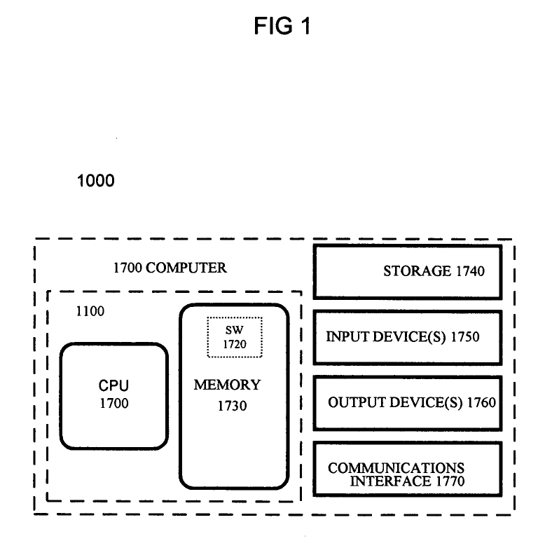

With reference to FIG. 1, scanning, encoding, printing, storing and retrieval of information may be implemented; for example, within a computing environment 1000, which includes at least one processing unit 1700 and memory 1730. In FIG. 1, this most basic configuration 1000 is included within a dashed line. The processing unit 1700 executes computer-executable instructions and may be a real or a virtual processor. In a multi-processing system, multiple processing units execute computer-executable instructions to increase processing power. The memory 1730 may be volatile memory (e.g., registers, cache, RAM), non-volatile memory (e.g., ROM, EEPROM, flash memory, etc.), or some combination of the two. The memory 1730 stores executable software—instructions and data 1250—written and operative to execute and implement the software applications required for an interactive environment supporting practice of the invention.

The computing environment may have additional features. For example, the computing environment 1000 includes storage 1740, one or more input devices 1750, one or more output devices 1760, and one or more communication connections or interfaces 1770. An interconnection mechanism (not shown) such as a bus, controller, or network interconnects the components of the computing environment. Typically, operating system software (not shown) provides an operating environment for other software executing in the computing environment, and coordinates activities of the components of the computing environment.

The storage 1740 may be removable or non-removable, and includes magnetic disks, CD-ROMs, DVDs, or any other medium which can be used to store information and which can be accessed within the computing environment. For example, the storage may store name, address and other information related to an offer made or information pertaining to the person offered. The storage 1740 also stores instructions for the software 1720, and is configured, for example, to store signal processing algorithms, databases storing card information, database software systems, intermediate results and data generated from sensor inputs.

The input device(s) 1750 may be a touch input device such as a keyboard, mouse, pen, or trackball, a voice input device, a scanning device, or another device that provides input to the computing environment. For audio or video, the input device(s) may be a sound card, video card, TV tuner card, or similar device that accepts audio or video input in analog or digital form. The output device(s) 1760 may be a display, printer, speaker, or another device that provides output from the computing environment.

The communication interface 1770 enable the operating system and software applications to exchange messages over a communication medium with the sensor device, and servo-mechanisms in various instantiations of the apparatus of the invention. The communication medium conveys information such as computer-executable instructions, and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The communications interface 1770 is used to communicate with other devices. For example, the interface 1770 may be attached to a network, such as the Internet, whereby the computing environment 1000 interchanges command, control and feedback signals with other computers, and devices.

### An Exemplary Embodiment of the Invention

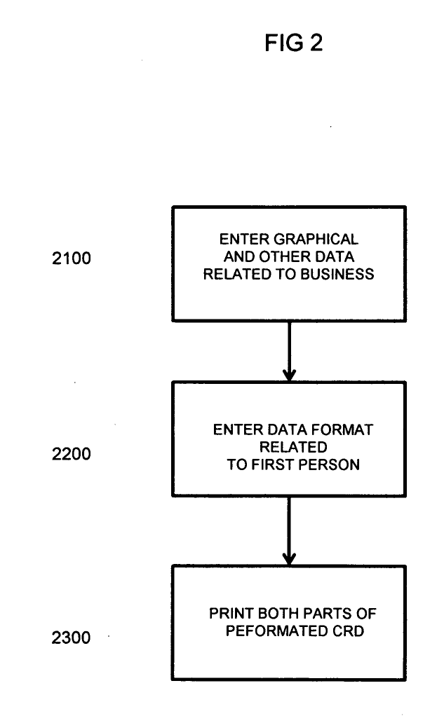

In FIG. 2 and the following figures, it is assumed that a business uses a computer system to process business referrals. The computer system shown in FIG. 1 and described above is also assumed.

Refer to FIG. 2. In FIG. 2, the business wishes to produce two part separable cards, which will convey certain data and information about the business. The cards will also be prepared to receive further encoding after the cards are printed. In step 2100 the business enters certain data related to the business (such as name, address and phone number) into the computer, Formats for receiving further data are also entered in step 2200. In step 2300 data related to certain referral incentives are into the computer, and in step 2400, the two-part card is printed.

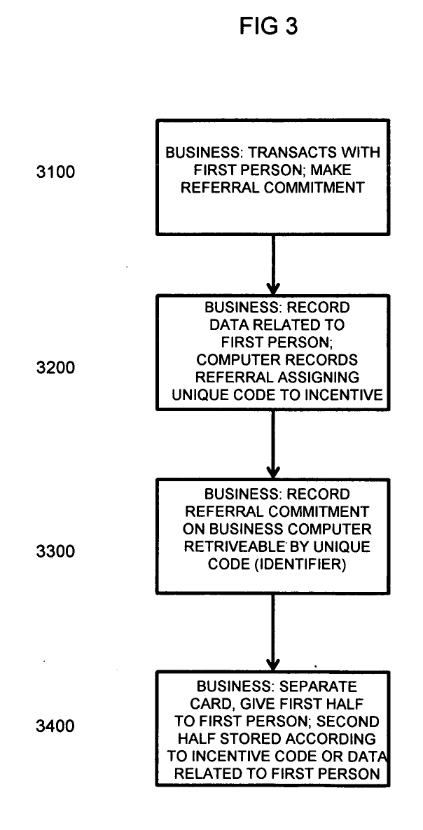

Refer now to FIG 3. In step 3100 the business engages a customer and makes a referral offer to the customer. The referral offer includes a specific incentive previously recorded on the computer system and which is assigned a code related to the incentive and the time frame in which the incentive may be obtained or rewarded. In step 3200 a unique identifier is assigned by the computer system, the unique identifier related to the code (or comprising the code) related to the incentive. For example, the code may relate to a specific service such as hair styling, which may be obtained as an incentive during a particular time or day of the week. In step 3300 various business incentives are displayed by the computer system and one is selected. For example, an appointment at a specific time or place, or a specific product or service at a specific price may be offered. In step 3400, the business (and the customer) selects the incentive. Customer data and the identification of the incentive are recorded on the computer, the recording retrievable by the unique identifier in step 3500. In step 3600 the card is further encoded with variable data not recordable on the computer (for example the offer's signature, etc.) In step 3700, the unique identifier and possibly other modifications to the offer are encoded on the two-part card. And in step 3800, the two part card is separated, the first part is given to the customer and the second card part is retained by the business.

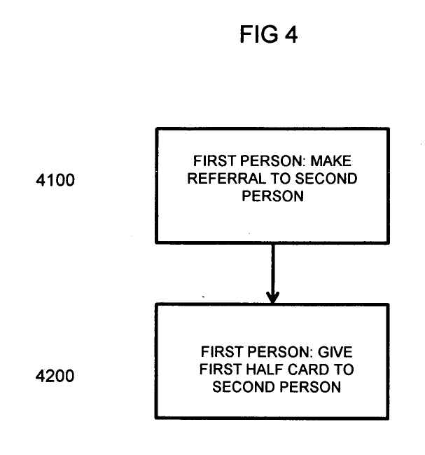

In FIG. 4, steps 4100 and 4200, the customer meets a second party and makes a referral of the business to the second party. The customer gives the first card part to the second party.

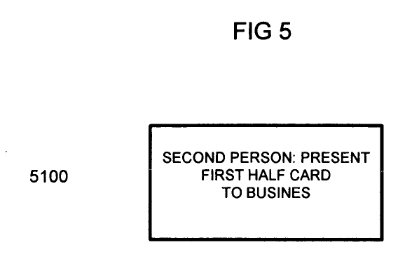

In FIG. 5, step 5100, the second party presents the first card half to the business.

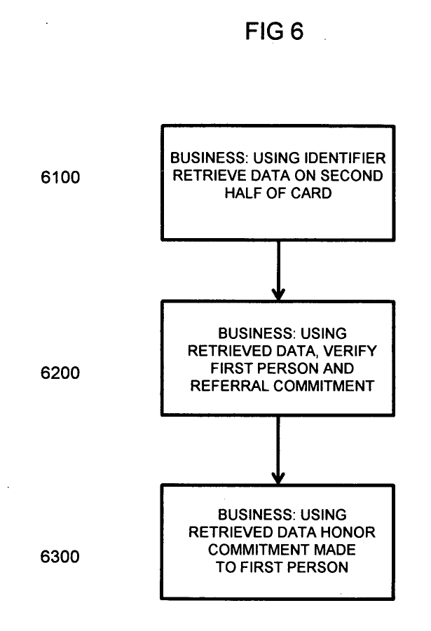

In FIG. 6, the business identifies the customer, and confirms the incentive offer. In step 6100 the business uses the unique identifier to retrieve the computer recording of customer data and to retrieve data related to the incentive offered. The unique identifier is used also to retrieve the second card part from a file. For example, the second part of the card may be stored in a manual file by type of incentive or may be stored and ordered by the date or by customer name (of the customer making the referral). Using the first card part, the second card the offer and customer are verified and confirmed. In step 6300 the business honors the referral incentive.

### Nature and Use of Identification Code for Referral

In order to prevent fraudulent use, the identification code for the referral is generated by and stored upon the computer. Also the code and identification of the referring customer may be kept on the computer database in case the referred person fails to present the first card half, but the referred person may quote the name of the referring customer, from which the database may be accessed to produce the identification code. Using the identification code, the business may access the file of the second card halves to confirm the incentive offer.

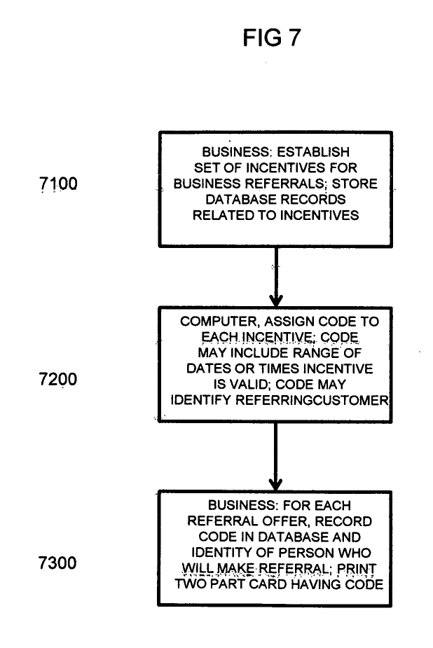

Refer now to FIG. 7. In FIG. 7 step 7100, the business decides what incentives will be given for referrals and records the set of referrals upon the computer. In step 7200, the computer system assigns a code to each incentive and may record information about the customer who may make the referral to a third party. The identification code may be a hash of the incentive description or the like. In step 7300, a record related to the referral and incentive is stored on the computer for later validation when the incentive is claimed.

### A First Aspect of the Invention

In the first aspect of the invention, the computer is operated by the business.

### A Second Aspect of the Invention

In the second aspect of the invention, the computer is operated by a third party, which provides the processing service to other businesses.

### DISCLOSURE SUMMARY

A computer system and method for recording a business referral transaction using a modifiable business card has been disclosed. The system and method has been illustrated by an exemplary embodiment. While other embodiments are conceivable, the nature and scope of the invention are delineated by the claims that follow.

I claim:

1. A computer method used by a business for recording, verifying and honoring a commitment made by the business to a first person for referring a second person to the business, the method comprising:
providing printing means for printing a perforated card having a first part given by the business to the first person and then by the first person to the second person, the perforated card having a second part, wherein the first part and second part have a common unique identifier;
providing data generation and recording means for generating and recording data related to the business, for generating and recording computer data related to the first person and for generating and recording data related to the referral commitment, the computer data retrievable by the common unique identifier, and;
providing data retrieval means for retrieving stored referral commitment data, said data retrieval made using said common identifier;
whereby
business first person and referral commitment data is captured, stored and printed on said two part card;
said two part card is printed, separated and the first part is given to the first person;
the first part is given by the first person to the second person;
the second part is presented to the business, and;
data from the second part is used to retrieve the referral commitment data.
